(19) United States
(12) Patent Application Publication
(10) Pub. No.: US 2001/0027559 A1
(43) Pub. Date: Oct. 4, 2001

(54) Broadcast system and advertising method for use in the same

(75) Inventors: Takumi Tanabe, Amagasaki-shi (JP); Takamasa Mitsunobu, Toyonaka-shi (JP); Tomonori Shiomi, Hirakata-shi (JP)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Matsushita Electric Industrial Co. Ltd.

(21) Appl. No.: 09/820,474

(22) Filed: Mar. 29, 2001

(30) Foreign Application Priority Data
Mar. 31, 2000 (JP) 2000-099308

(51) Int. Cl. H04N 7/16

(52) U.S. Cl. 725/1

(57) ABSTRACT

The invention is directed to producing commercials at low cost, providing interactive advertising, and presenting commercials that match the tastes of actual viewers. A television broadcast receiver comprises a browser unit for reproducing display data coded by the Hyper Text Markup Language, a storage unit for storing at least one piece of advertising information made up of display data coded by the Hyper Text Markup Language, and an Internet access unit for accessing the Internet to obtain display data coded by the Hyper Text Markup Language, wherein the broadcast station transmits, prior to or during the transmission of contents an advertising scenario header for at least instructing what kind of advertising information should be reproduced and in what way, and during the reception and reproduction of the contents the television broadcast receiver reproduces the advertising information stored in the storage unit, by using the browser unit, and also accesses the display data on the Internet by using the Internet access unit and reproduces information, obtained by accessing the display data, as the advertising information by using the browser unit in accordance with the contents of the advertising scenario header received from the broadcast station.

### BACKGROUND OF THE INVENTION

The present invention relates to a broadcast system for cable television (CATV), satellite broadcasting and the like, more particularly, a broadcast system in which a broadcast station and each of a plurality of television broadcast receivers are connected by a two-way channel, and an advertising method for use in such a broadcast system.

In recent years, with advances in digital coding techniques of video and audio signals, digital television broadcasting has begun to spread widely to succeed the traditional analog television broadcasting. Digital television broadcasting provides features that permit video programs (contents) to be transmitted with a narrower bandwidth and allow the use of higher frequency carriers, thus enabling simultaneous transmission of contents several times larger in amount than is possible with the traditional analog television broadcasting.

Among new applications currently studied to provide services in the digital television age are interactive video services represented by video on demand (VOD). In a VOD system, a video server at the transmitting end and a set top box (STB) at the receiving end are connected by a two-way channel, and a viewer can perform operations, such as play, rewind, fast forward, and pause, on any desired video program by sending signals over the upstream channel going from the STB to the video server.

VOD is a very attractive application, but unlike traditional television broadcasting in which a large number of viewers watch the same contents simultaneously, the number of viewers of each piece of contents is limited. Accordingly, directly applying the advertising method of producing and broadcasting advertising information (commercials), as employed in the traditional television broadcasting, has not been realistic in the case of VOD for cost and various other reasons.

To describe more specifically, in the traditional television broadcasting, commercials are inserted during the broadcasting of contents, and the advertisers thus bear the costs of broadcasting and contents production on behalf of viewers. In the case of VOD, however, since the production cost of a commercial is very high, inserting a commercial in each piece of VOD contents having a limited number of viewers can lead to problems such as degraded service, increased charges to viewers, etc.

On the other hand, according to the advertising method employed in the traditional television broadcasting, commercials are presented for being viewed by all the viewers watching the contents. The purpose of any commercial is to entice viewers to purchase the product advertised by the commercial, but the traditional advertising method has not been able to fully satisfy the advertiser's desire that the commercial be watched by viewers interested in the product.

Furthermore, since this advertising method allows only one-way transmission of commercials from the advertiser to the viewer, a survey using means exemplified by questionnaires has had to be conducted if the advertiser wants to know the effect and impact of the commercial, such as what class of viewers watched the commercial and what impressions they had.

There are prior arts to improve the advertising method employed in the traditional television broadcasting and to be adapted for VOD; one example of such a broadcast system and advertising method is disclosed in Japanese Unexamined Patent Publication No. 10-79711, entitled COMMERCIAL INFORMATION SELECTION AND REPRODUCTION METHOD AND BROADCAST SYSTEM.

According to this prior art broadcast system and advertising method, commercials are transmitted in advance to each viewer's television broadcast receiver for storing therein. Further, each television broadcast receiver has limiting information pre-stored therein for instructing the selection of commercials so that, of the commercials transmitted from the broadcast station, commercials that match the viewer's interest are selectively stored.

The broadcast station transmits each piece of contents by multiplexing thereon commercial reference information indicating commercial insertion time, etc. Each television broadcast receiver receiving the contents displays the stored commercials during the broadcasting of the contents in accordance with the commercial reference information multiplexed on the contents. Furthermore, each television broadcast receiver transmits selection information indicating the displayed commercial to the broadcast station by using the upstream channel.

In this way, the prior art broadcast system and advertising method described above allows each viewer to view commercials that match his or her taste, and enables the advertisers to know what class of viewers have watched their commercials.

The prior art broadcast system and advertising method described above, however, does not disclose any method for producing commercials at low cost, and has not been suitable for application to digital television broadcasting. To describe more specifically, with digital television broadcasting, very many pieces of contents can be broadcast compared with the traditional analog television broadcasting, as previously noted. However, according to the prior art broadcast system and advertising method described above, many commercials have had to be produced for each piece of contents, and as many advertisers have had to be found. Furthermore, since the production costs of commercials are very high, it has been difficult to find advertisers for many pieces of contents. As a result, if the prior art broadcast system and advertising method were used for application to digital television broadcasting, either contents delivery service would degrade, resulting in reduced variety of contents being able to be provided to viewers, or contents production costs would have to be passed to the viewers.

According to the prior art broadcast system and advertising method described above, advertisers have been able to know what class of viewers watched their commercials, but they have not been able to know the effect and impact of their commercials such as viewers' impressions of the commercials. Furthermore, the prior art broadcast system and advertising method has not been able to efficiently broadcast commercials, and has fallen short of fully satisfying the advertiser's desire. More specifically, the prior art broadcast system and advertising method has not been able to satisfy the advertiser's desire that the commercial be watched by those suitable viewers to whom the advertiser wishes to present the commercial, or that the advertiser receive orders directly from viewers who watched the commercial. With the prior art broadcast system and advertising method described above, the advertiser after all has not been able to know whether the viewers actually watched the commercial, that i s, whether the viewers were sitting before their television broadcast receivers when the commercial was run.

According to the prior art broadcast system and advertising method described above, it is claimed that by pre-registering the limiting information with the television broadcast receiver, the viewer can be presented with commercials that match his or her interest. However, in many cases, one television broadcast receiver is shared by all family members, and there are cases where broadcast contents is watched by all the family members or by only some of the family members. As a result, with the prior art broadcast system and advertising method, if the tastes of all the family members are pre-registered with the television broadcast receiver, the advertiser or the broadcast station has not been able to know who in the family has watched the contents or the commercial. With the prior art broadcast system and advertising method, therefore, it has been difficult to present commercials that match the tastes of actual viewers, especially in the case of a family consisting of people with a wide variety of ages.

The present invention has been devised to solve the above outlined problems, and an object of the invention is to provide a broadcast system and an advertising method for use in the same by which commercials can be produced at low cost, so that many commercials can be easily presented to viewers.

Another object of the invention is to provide a broadcast system and an advertising method for use in the same that permit the advertiser to easily know the effect and impact of their commercial, and that present interactive advertising in which orders can be received directly from viewers who watched the commercial.

A further object of the invention is to provide a broadcast system and an advertising method for use in the same that can present commercials that meet the tastes of actual viewers.

### SUMMARY OF THE INVENTION

According to the present invention, there is provided a broadcast system comprising a broadcast station and a television broadcast receiver connected to the broadcast station by a two-way channel, wherein

the television broadcast receiver comprises a browser unit for reproducing display data coded by the Hyper Text Markup Language, and a storage unit for storing at least one piece of advertising information made up of display data coded by the Hyper Text Markup Language, and wherein

the broadcast station transmits, prior to or during the transmission of contents an advertising scenario header for at least instructing what kind of advertising information should be reproduced and in what way, and

during the reception and reproduction of the contents the television broadcast receiver reproduces the advertising information stored in the storage unit by means of the browser unit in accordance with the contents of the advertising scenario header received from the broadcast station.

With the above configuration, advertising information (commercials) can be produced at low cost, so that a variety of commercials can be easily presented to the viewer.

According to another aspect of the invention, there is provided a broadcast system comprising a broadcast station and a television broadcast receiver connected to the broadcast station by a two-way channel, wherein

the television broadcast receiver comprises a browser unit for reproducing display data coded by the Hyper Text Markup Language, and an Internet access unit for accessing the Internet to obtain display data coded by the Hyper Text Markup Language, and wherein

the broadcast station transmits, prior to or during the transmission of contents an advertising scenario header for at least instructing what kind of advertising information should be reproduced and in what way, and

during the reception and reproduction of the contents the television broadcast receiver accesses the display data on the Internet by means of the Internet access unit, and reproduces information, obtained by accessing the display data, as the advertising information by means of the browser unit in accordance with the contents of the advertising scenario header received from the broadcast station.

With the above configuration, commercials can be produced at low cost, so that a variety of commercials can be easily presented to the viewer. Furthermore, the advertiser can update the contents of the advertising information any time when the need arises, and the viewer can thus view the latest advertising information.

According to another aspect of the invention, there is provided a broadcast system comprising a broadcast station and a television broadcast receiver connected to the broadcast station by a two-way channel, wherein

the television broadcast receiver comprises a browser unit for reproducing display data coded by the Hyper Text Markup Language, a storage unit for storing at least one piece of advertising information made up of display data coded by the Hyper Text Markup Language, and an Internet access unit for accessing the Internet to obtain display data coded by the Hyper Text Markup Language, and wherein

the broadcast station transmits, prior to or during the transmission of contents an advertising scenario header for at least instructing what kind of advertising information should be reproduced and in what way, and

during the reception and reproduction of the contents the television broadcast receiver reproduces the advertising information stored in the storage unit by means of the browser unit, and accesses the display data on the Internet by means of the Internet access unit and reproduces information, obtained by accessing the display data, as the advertising information by means of the browser unit in accordance with the contents of the advertising scenario header received from the broadcast station.

With the above configuration, commercials can be produced at low cost, so that a variety of commercials can be easily presented to the viewer. Furthermore, the advertiser can update the contents of the advertising information any time when the need arises, and the viewer can thus view the latest advertising information.

According to another aspect of the invention, there is provided a broadcast system which incorporates the configuration described in any one of the foregoing aspects, and is further characterized in that

the television broadcast receiver comprises an input unit for inputting data,

the advertising information includes input instruction of limiting information for reproducing a description instructing to input limiting information using the input unit,

the advertising scenario header includes information for instructing to resume the reproduction of the contents or the advertising information after data has been inputted using the input unit in response to the reproduced input instruction of limiting information, and also includes information for instructing in accordance with the contents of the limiting information what kind of advertising information should be reproduced, and

the television broadcast receiver reproduces the advertising information during the reception and reproduction of the contents in accordance with the contents of the advertising scenario header and the limiting information inputted from the input unit.

With the above configuration, not only can the advertiser easily grasp the effect and impact of the commercial, but interactive advertising can also be provided that enables the advertiser to receive orders for the advertised product directly from viewers who watched the commercial. Furthermore, commercials that match the tastes of actual viewers can be presented.

According to another aspect of the invention, there is provided a broadcast system which incorporates the configuration described in any one of the foregoing aspects, and is further characterized in that

the television broadcast receiver comprises a reproduction control unit for controlling the reproduction of the contents and

the television broadcast receiver instructs the broadcast station through the reproduction control unit to temporarily stop the transmission of the contents when starting the reproduction of the advertising information during the reception and reproduction of the contents and instructs the broadcast station through the reproduction control unit to restart the transmission of the contents when ending the reproduction of the advertising information.

With the above configuration, each television broadcast receiver can control the commercial displaying time and, since the reproduction of the contents is controlled at the television broadcast receiver side, the load at the broadcast station can be alleviated.

According to another aspect of the invention, there is provided a broadcast system which incorporates the configuration described in any one of the foregoing aspects, and is further characterized in that

a data gathering unit for receiving data from the television broadcast receiver and for storing the data is provided at least either in the broadcast station or on the Internet,

the television broadcast receiver comprises a data input unit for inputting data, and a data transmitting unit for transmitting the data to the data gathering unit,

the advertising information includes data input instruction information for reproducing a description instructing to input data using the input unit,

the advertising scenario header includes information for instructing to resume the reproduction of the contents or the advertising information after the data has been inputted using the input unit in response to the reproduced data input instruction information, and

the television broadcast receiver transmits the contents of the data inputted from the input unit, to the data gathering unit by means of the data transmitting unit.

With the above configuration, the advertiser can collect information such as viewers' impressions of the commercial and the advertised product. Furthermore, the viewer can order the advertised product on the spot.

According to the present invention, there is also provided an advertising method for use in a broadcast system comprising a broadcast station and a television broadcast receiver connected to the broadcast station by a two-way channel, wherein

the television broadcast receiver comprises a browser unit for reproducing display data coded by the Hyper Text Markup Language, and a storage unit for storing at least one piece of advertising information made up of display data coded by the Hyper Text Markup Language, and wherein

an advertising scenario header for at least instructing what kind of advertising information should be reproduced and in what way, is transmitted from the broadcast station to the television broadcast receiver prior to or during the transmission of contents and

during the reception and reproduction of the contents the television broadcast receiver reproduces the advertising information stored in the storage unit by means of the browser unit in accordance with the contents of the advertising scenario header received from the broadcast station.

With the above configuration, commercials can be produced at low cost, so that a variety of commercials can be easily presented to the viewer.

According to another aspect of the invention, there is provided an advertising method for use in a broadcast system comprising a broadcast station and a television broadcast receiver connected to the broadcast station by a two-way channel, wherein

the television broadcast receiver comprises a browser unit for reproducing display data coded by the Hyper Text Markup Language, and an Internet access unit for accessing the Internet to obtain display data coded by the Hyper Text Markup Language, and wherein

an advertising scenario header for at least instructing what kind of advertising information should be reproduced and in what way, is transmitted from the broadcast station to the television broadcast receiver prior to or during the transmission of contents and

during the reception and reproduction of the contents the television broadcast receiver accesses the display data on the Internet by means of the Internet access unit, and reproduces information, obtained by accessing the display data, as the advertising information by means of the browser unit in accordance with the contents of the advertising scenario header received from the broadcast station.

With the above configuration, commercials can be produced at low cost, so that a variety of commercials can be easily presented to the viewer. Furthermore, the advertiser can update the contents of the advertising information any time when the need arises, and the viewer can thus view the latest advertising information.

According to another aspect of the invention, there is provided an advertising method for use in a broadcast system comprising a broadcast station and a television broadcast receiver connected to the broadcast station by a two-way channel, wherein

the television broadcast receiver comprises a browser unit for reproducing display data coded by the Hyper Text Markup Language, a storage unit for storing at least one piece of advertising information made up of display data coded by the Hyper Text Markup Language, and an Internet access unit for accessing the Internet to obtain display data coded by the Hyper Text Markup Language, and wherein

an advertising scenario header for at least instructing what kind of advertising information should be reproduced and in what way, is transmitted from the broadcast station to the television broadcast receiver prior to or during the transmission of contents and

during the reception and reproduction of the contents the television broadcast receiver reproduces the advertising information stored in the storage unit by means of the browser unit and accesses the display data on the Internet by means of the Internet access unit and reproduces information, obtained by accessing the display data, as the advertising information by means of the browser unit in accordance with the contents of the advertising scenario header received from the broadcast station.

With the above configuration, commercials can be produced at low cost, so that a variety of commercials can be easily presented to the viewer. Furthermore, the advertiser can update the contents of the advertising information any time when the need arises, and the viewer can thus view the latest advertising information.

According to another aspect of the invention, there is provided an advertising method for use in a broadcast system, which incorporates the configuration described in any one of the foregoing aspects, and is characterized in that

the television broadcast receiver comprises an input unit for inputting data,

the advertising information includes input instruction of limiting information for reproducing a description instructing to input limiting information using the input unit,

the advertising scenario header includes information for instructing to resume the reproduction of the contents or the advertising information after data has been inputted using the input unit in response to the reproduced input instruction of limiting information, and also includes information for instructing in accordance with the contents of the limiting information what kind of advertising information should be reproduced, and

the television broadcast receiver reproduces the advertising information during the reception and reproduction of the contents in accordance with the contents of the advertising scenario header and the limiting information inputted from the input unit.

With the above configuration, not only can the advertiser easily grasp the effect and impact of the commercial, but interactive advertising can also be provided that enables the advertiser to receive orders for the advertised product directly from viewers who watched the commercial. Furthermore, commercials that match the tastes of actual viewers can be presented.

According to another aspect of the invention, there is provided an advertising method for use in a broadcast system, which incorporates the configuration described in any one of the foregoing aspects, and is characterized in that

the television broadcast receiver comprises a reproduction control unit for controlling the reproduction of the contents and

the television broadcast receiver instructs the broadcast station through the reproduction control unit to temporarily stop the transmission of the contents when starting the reproduction of the advertising information during the reception and reproduction of the contents and instructs the broadcast station through the reproduction control unit to restart the transmission of the contents when ending the reproduction of the advertising information.

With the above configuration, each television broadcast receiver can control the commercial displaying time and, since the reproduction of the contents is controlled at the television broadcast receiver side, the load at the broadcast station can be alleviated.

According to another aspect of the invention, there is provided an advertising method for use in a broadcast system, which incorporates the configuration described in any one of the foregoing aspects, and is characterized in that

a data gathering unit for receiving data from the television broadcast receiver and for storing the data is provided at least either in the broadcast station or on the Internet,

the television broadcast receiver comprises a data input unit for inputting data, and a data transmitting unit for transmitting the data to the data gathering unit,

the advertising information includes data input instruction information for reproducing a description instructing to input data using the input unit,

the advertising scenario header includes information for instructing to resume the reproduction of the contents or the advertising information after the data has been inputted using the input unit in response to the reproduced data input instruction information, and

the television broadcast receiver transmits the contents of the data inputted from the input unit, to the data gathering unit by means of the data transmitting unit.

With the above configuration, the advertiser can collect information such as viewers' impressions of the commercial and the advertised product. Furthermore, the viewer can order the advertised product on the spot.

The novel features of the invention will be hereinafter fully described and particularly pointed out in the appended claims, and the configuration and details of the invention, together with other objects and features thereof, will become better understood and appreciated by reference to the following detailed description when considered in conjunction with the accompanying drawings.

### BRIEF DESCRIPTION OF THE INVENTION

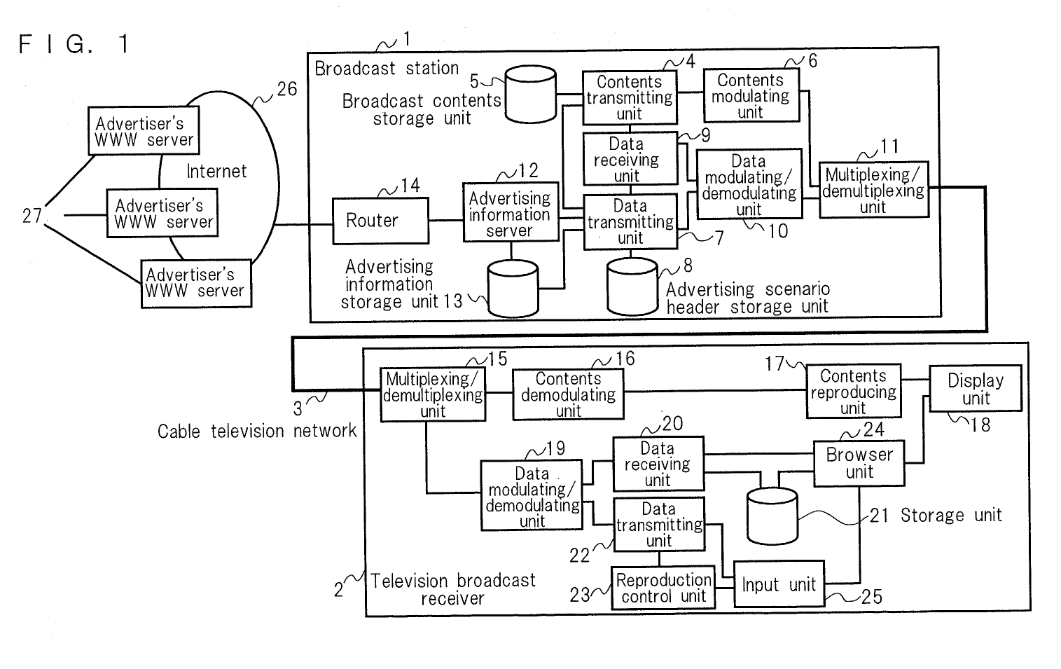

FIG. 1 is a block diagram showing the configuration of a broadcast system according to a first embodiment of the present invention.

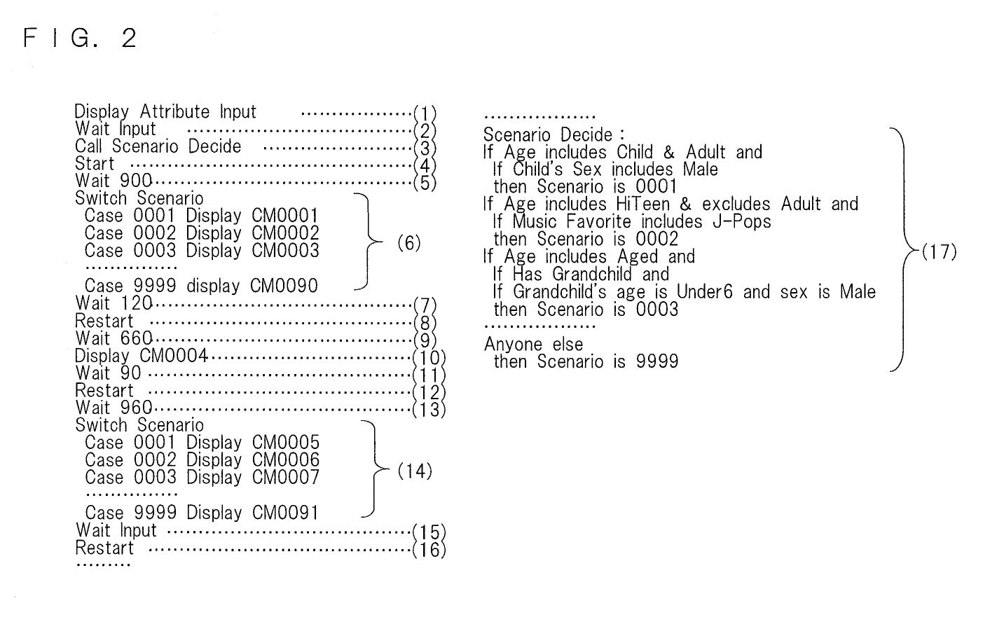

FIG. 2 is an explanatory diagram showing a specific example of the advertising scenario header used in the broadcast system of FIG. 1.

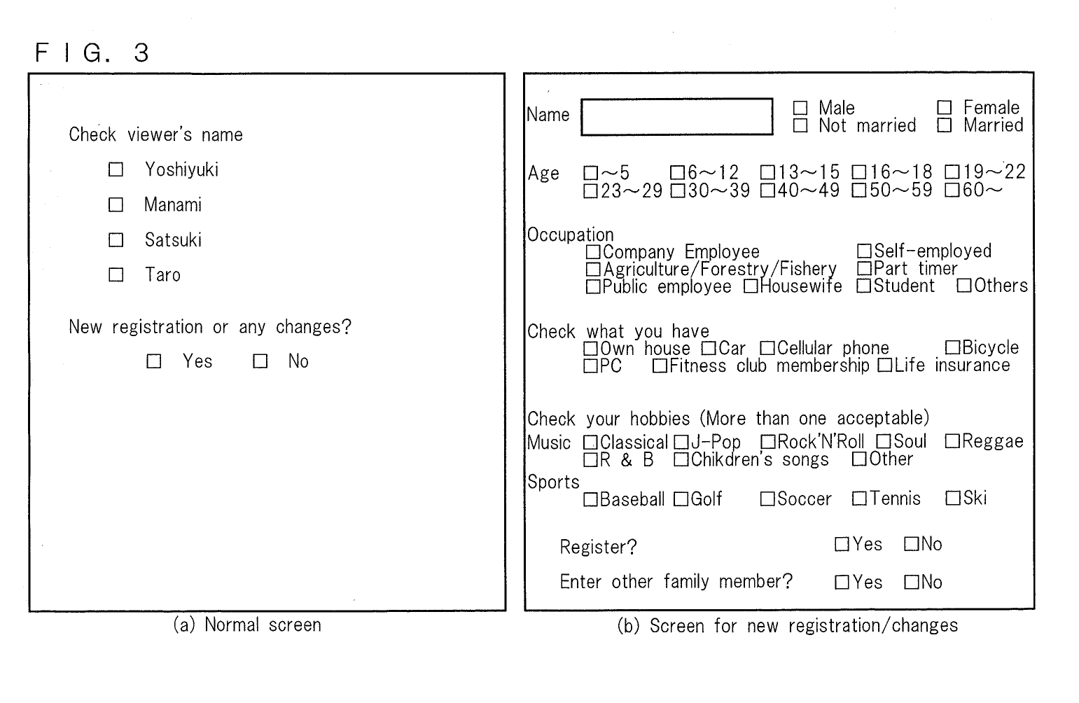

FIG. 3 is an explanatory diagram showing a specific example of an input screen for inputting limiting information, displayed on a display unit in FIG. 1.

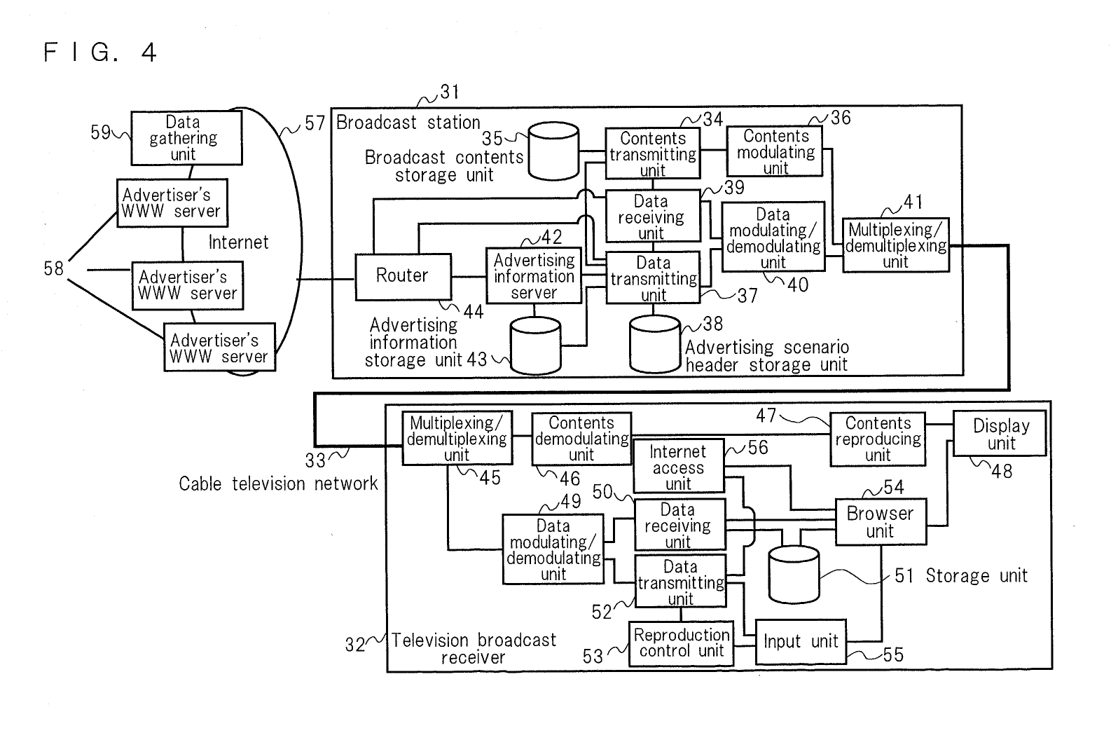

FIG. 4 is a block diagram showing the configuration of a broadcast system according to a second embodiment of the present invention.

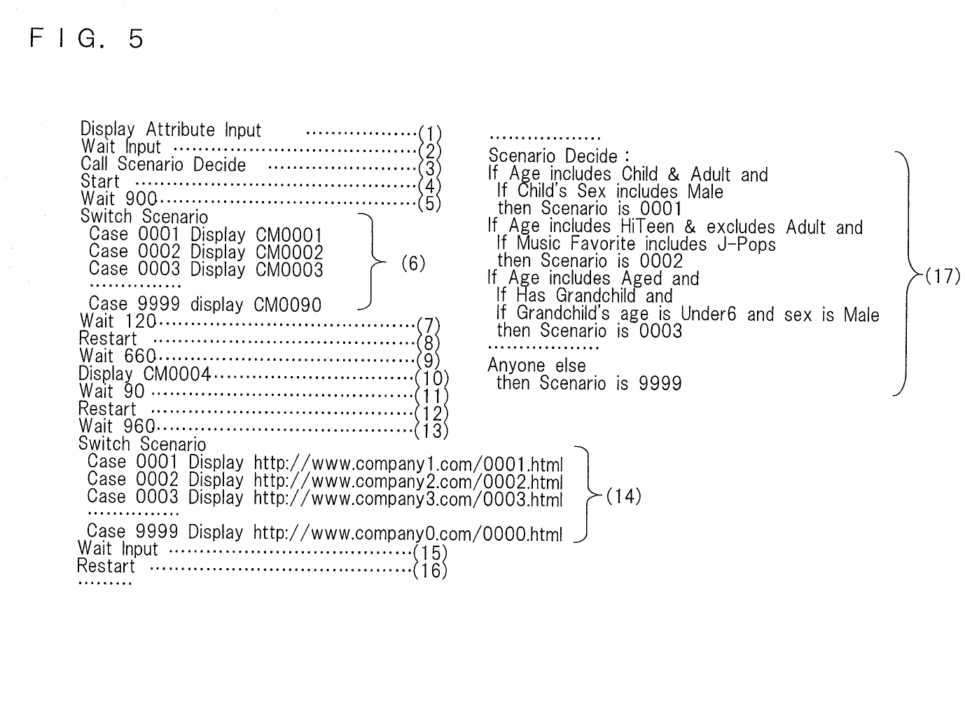

FIG. 5 is an explanatory diagram showing a specific example of the advertising scenario header used in the broadcast system of FIG. 4.

It will be understood that all or part of the drawings are purely diagrammatic for illustrative purposes and do not necessarily present faithful depictions of the actual relative sizes or positions of the illustrated elements.

### DETAILED DESCRIPTION OF THE INVENTION

Preferred embodiments showing the broadcast system and advertising method of the present invention will be described below with reference to the accompanying drawings. The following description deals with examples in which the broadcast system and advertising method of the present invention is applied to a cable television (CATV) broadcast system. In an alternative embodiment, the invention may be applied to a satellite broadcast or terrestrial broadcast system having upstream channels going to the broadcast station.

### Embodiment 1

### Configuration of the Broadcast System

FIG. 1 is a block diagram showing the configuration of a broadcast system according to a first embodiment of the present invention.

As shown in FIG. 1, the broadcast system of the first embodiment comprises a broadcast station 1 and a television broadcast receiver 2 connected to the broadcast station 1 via a cable television network 3. The cable television network 3 is constructed with coaxial cable or optical fiber cable on which many frequency channels (two-way channels) are multiplexed using frequency division multiplexing. These frequency channels consist of a plurality of channels going from the television broadcast receiver 2 to the broadcast station 1 (hereinafter called the “upstream channels”) and a plurality of channels going from the broadcast station 1 to the television broadcast receiver 2 (hereinafter called the “downstream channels”). For purposes of simplification, only one television broadcast receiver 2 is shown in FIG. 1, though actually a plurality of television broadcast receivers 2 are connected to the cable television network 3.

Inside the broadcast station 1 are provided a contents transmitting unit 4 and contents modulating unit 6 for transmitting broadcast contents (hereinafter called the “contents”) stored in a broadcast contents storage unit 5, and a data transmitting unit 7, data receiving unit 9, and data modulating/demodulating unit 10 for performing two-way data communications with the television broadcast receiver 2. The contents modulating unit 6 and data modulating/demodulating unit 10 are connected to the cable television network 3 via a multiplexing/demultiplexing unit 11.

The broadcast contents storage unit 5 is constructed with a data storage apparatus such as hard disks, and stores a plurality of pieces of contents such as video programs. Each piece of contents is managed by an identifier appended to it. Further, for each piece of contents there is provided an advertising scenario header for at least instructing what kind of advertising information should be reproduced for the contents and how it should be reproduced. More specifically, the data transmitting unit 7 creates the advertising scenario header in advance for each piece of contents stored in the broadcast contents storage unit 5, and stores the thus created advertising scenario header in an advertising scenario header storage unit 8. Prior to or during the transmission of the contents the data transmitting unit 7 transmits the advertising scenario header corresponding to the contents to the television broadcast receiver 2. As described later, a description instructing to display a WWW page prompting the viewer to input limiting information is included at the beginning of the advertising scenario header. The header also contains the timing for displaying the advertising information and the identifier of the advertising information to be displayed in accordance with the limiting information. A description instructing how the advertising information is to be ended, for example, it should be ended after prescribed time has elapsed or by an input from the viewer, is also contained in the header.

The broadcast station 1 also includes an advertising information server 12, advertising information storage unit 13, and router 14 for acquiring and managing advertising information (commercials) produced by advertisers. The advertising information server 12 accesses an advertiser's WWW server 27 on the Internet 26 via the router 14, acquires new advertising information from the advertiser's WWW server 27, and stores it in the advertising information storage unit 13.

The advertising information is produced as a so-called WWW (World Wide Web) page, that is, display data coded by HTML (Hyper Text Markup Language). Production of WWW pages is generally lower in cost than the production of traditional commercials; in particular, update costs are extremely low, and simple updating of the contents can be done even by individuals, not professionals, if they are given adequate training. Accordingly, the broadcast system of the first embodiment permits production of commercials at low cost and can therefore provide many pieces of contents to the viewer free of charge or at low cost.

The television broadcast receiver 2 comprises a multiplexing/demultiplexing unit 15 connected to the cable television network 3, and a contents demodulating unit 16, contents reproducing unit 17, and display unit 18 connected in this order to the multiplexing/demultiplexing unit 15 for displaying the contents on the display unit 18 received from the broadcast station 1. The television broadcast receiver 2 further comprises a data modulating/demodulating unit 19 connected to the multiplexing/demultiplexing unit 15, a data receiving unit 20 and data transmitting unit 22 connected to the data modulating/demodulating unit 19, and a storage unit 21 connected to the data receiving unit 20 for storing at least one piece of advertising information. The television broadcast receiver 2 further includes a reproduction control unit 23 connected to the data transmitting unit 22 for controlling the reproduction of the contents, a browser unit 24 for reproducing the advertising information (WWW page) at least in accordance with the advertising scenario header stored in the storage unit 21, and an input unit 25 for inputting data.

The television broadcast receiver 2 in the broadcast system of the first embodiment allows the viewer using the input unit 25 to input not only the contents he or she desires to watch but also the limiting information for limiting the advertising information to be presented for viewing. One specific example of the limiting information is personal information such as the viewer's taste, age, etc. Using the input unit 25, the viewer inputs the limiting information in accordance with input instruction of limiting information presented, for example, in the form of a WWW page written in HTML (details will be described later). The input instruction of limiting information is transmitted from the broadcast station 1 by being included in the advertising information, and stored in advance in the storage unit 21. The television broadcast receiver 2 reproduces the advertising information during the reception and reproduction of the contents in accordance with the contents of the advertising scenario header and the input limiting information. The broadcast system of the first embodiment thus permits the viewer to view the advertising information that matches his or her interest. The advertiser, in turn, can deliver advertising information to the viewer on whom the advertising information is likely to have an impact.

When starting the reproduction of the advertising information during the reception and reproduction of the contents, the reproduction control unit 23 instructs the broadcast station 1 to temporarily stop the transmission of the contents by using a pause means. When ending the reproduction of the advertising information, the reproduction control unit 23 instructs the broadcast station 1 to restart the transmission by using a restart means. In this way, in the broadcast system of the first embodiment, commercial viewing time can be determined for each individual viewer. Furthermore, since the reproduction of the contents is controlled at the television broadcast receiver side, the load at the broadcast station 1 can be alleviated.

### Operation of the Broadcast System

Operation of the broadcast system configured as described above will be described in detail with reference to FIG. 1.

The advertising information server 12 in the broadcast station 1 periodically accesses the plurality of advertisers' WWW servers 27 on the Internet 26 via the router 14. The advertising information server 12 then stores advertising information written in HTML in the advertising information storage unit 13 and updates the stored information. The updated advertising information is transmitted during a particular time segment of the day, for example, late at night, to the television broadcast receiver 2 for storing in the storage unit 21.

To describe in detail, at the broadcast station 1, the advertising information stored in the advertising information storage unit 13 is assembled as an advertising information frame by the data transmitting unit 7, coded and modulated by the data modulating/demodulating unit 10, and transmitted out via the multiplexing/demultiplexing unit 11 onto the downstream channel on the cable television network 3.

At the television broadcast receiver 2, the data modulating/demodulating unit 19 receives the advertising information frame via the multiplexing/demultiplexing unit 15 and, after demodulating and decoding, passes it to the data receiving unit 20. The data receiving unit 20 recognizes it as an advertising information frame, and stores the contents (data) of the advertising information in the storage unit 21 together with its identifier.

Here, each piece of advertising information is transmitted as one advertising information frame. Therefore, when more than one advertising information frame is transmitted, each advertising information frame contains an identifier appended to it. These advertising information frames are transmitted to all the television broadcast receivers 2 connected to the cable television network 3.

When the viewer specifies the contents he or she desired to receive by using the input unit 25 of the television broadcast receiver 2, the data transmitting unit 22 creates a contents request frame containing the identifier of the specified contents. The contents request frame is coded and modulated by the data modulating/demodulating unit 19 and transmitted out via the multiplexing/demultiplexing unit 15 onto the upstream channel on the cable television network 3.

The contents request frame transmitted onto the cable television network 3 is delivered via the multiplexing/demultiplexing unit 11 to the data modulating/demodulating unit 10 in the broadcast station 1 where it is demodulated and decoded. The decoded frame is passed to the data receiving unit 9 which recognizes it as a contents request frame. The data receiving unit 9 reports the identifier of the requested contents to the data transmitting unit 7. The data transmitting unit 7 retrieves from the advertising scenario header storage unit 8 the advertising scenario header corresponding to the contents designated by the specified identifier.

Next, the data transmitting unit 7 passes the scenario header frame containing the retrieved advertising scenario header to the data modulating/demodulating unit 10 where the scenario header frame is coded and modulated for transmission onto the cable television network 3 via the multiplexing/demultiplexing unit 11.

Upon receiving notification from the data modulating/demodulating unit 10 that the transmission of the scenario header frame is completed, the data transmitting unit 7 reports the identifier of the requested contents to the contents transmitting unit 4. The contents transmitting unit 4 retrieves the contents designated by the specified identifier from the broadcast contents storage unit 5, and passes the retrieved contents to the contents modulating unit 6. The contents modulating unit 6 modulates the broadcast contents and transmits it onto the cable television network 3 via the multiplexing/demultiplexing unit 11.

At the television broadcast receiver 2, the data modulating/demodulating unit 19 receives the scenario header frame via the multiplexing/demultiplexing unit 15. The data modulating/demodulating unit 19 demodulates and decodes the received scenario header frame, and passes it to the data receiving unit 20. The data receiving unit 20 recognizes the received frame as a scenario header frame, extracts the advertising scenario header from the scenario header frame, and stores the extracted header in the storage unit 21. Further, the data receiving unit 20 notifies the browser unit 24 of the reception of the advertising scenario header.

Next, the browser unit 24 refers to the storage unit 21 and, in accordance with the contents of the stored advertising scenario header, instructs the display unit 18 to display a WWW page prompting for entry of limiting information. At this time, the browser unit 24 instructs the reproduction control unit 23 to temporarily stop the reproduction of the contents. The WWW page prompting for entry of limiting information is stored in advance in the storage unit 21.

Next, the reproduction control unit 23 sends a contents pause request to the data transmitting unit 22. The data transmitting unit 22 creates a pause request frame containing the identifier of the contents and passes it to the data modulating/demodulating unit 19. The data modulating/demodulating unit 19 codes and modulates the pause request frame, and transmits it out on the cable television network via the multiplexing/demultiplexing unit 15.

At the television broadcast receiver 2, the contents transmitted from the broadcast station 1 are inputted via the multiplexing/demultiplexing unit 15 to the contents demodulating unit 16 for demodulation and decoding. The contents reproducing unit 17 reproduces the received contents for display on the display unit 18.

Next, at the broadcast station 1, the data modulating/demodulating unit 10 receives the pause request frame via the multiplexing/demultiplexing unit 11, demodulates and decodes the received pause request frame, and passes it to the data receiving unit 9. The data receiving unit 9 recognizes the frame as a pause request frame, and instructs the contents transmitting unit 4 to temporarily stop the transmission of the contents corresponding to the identifier contained in the frame. In response to the instruction from the data receiving unit 9, the contents transmitting unit 4 temporarily stops the transmission of the corresponding contents.

On the other hand, at the television broadcast receiver 2, when the viewer inputs limiting information such as his or her taste, age, etc. using the input unit 25, the input unit 25 sends the limiting information and a limiting information entry completion notification to the browser unit 24. The limiting information is coded by the browser unit 24 and stored in the storage unit 21.

Next, the browser unit 24 instructs the reproduction control unit 23 to restart the reproduction of the contents. The reproduction control unit 23 sends the restart request to the data transmitting unit 22 which in response creates a restart request frame. This frame contains the identifier of the contents. The data transmitting unit 22 sends the restart request frame to the data modulating/demodulating unit 19, which codes and modulates the restart request frame and transmits it via the multiplexing/demultiplexing unit 15 onto the upstream channel on the cable television network 3. As in the case of the pause request frame, the restart request frame is sent to the data receiving unit 9 in the broadcast station 1.

Next, the data receiving unit 9 instructs the contents transmitting unit 4 to restart the transmission of the contents specified by the identifier contained in the restart request. The contents transmitting unit 4 restarts the transmission of the specified contents.

At the television broadcast receiver 2, the browser unit 24 presents the advertising information stored in the storage unit 21 for display on the display unit 18 in accordance with the limiting information and the contents of the advertising scenario header stored in the storage unit 21. The browser unit 24 sends the contents pause request to the reproduction control unit 23 immediately before initiating the display of the advertising information, and sends the restart request to the reproduction control unit 23 immediately after ending the display. The temporarily stopping and restarting of the transmission of the contents is thus effected in accordance with the above-described procedure.

Referring now to FIG. 2 and parts (a) and (b) of FIG. 3, the operation of the television broadcast receiver 2, performed in accordance with the advertising scenario header, will be described in detail below.

FIG. 2 is an explanatory diagram showing a specific example of the advertising scenario header used in the broadcast system of FIG. 1. Part (a) of FIG. 3 is an explanatory diagram showing a specific example of the limiting information input screen presented for display on the display unit shown in FIG. 1, and part (b) of FIG. 3 is an explanatory diagram showing another specific example of the input screen.

As shown at (1) in FIG. 2, the advertising scenario header first instructs the viewer to input limiting information. At this time, the television broadcast receiver 2 sends the pause request frame to the broadcast station 1 and stops the reproduction of the contents as earlier described. As indicated at (2) in FIG. 2, the television broadcast receiver 2 waits until the viewer inputs the limiting information; during this period, the screen shown in part (a) or (b) of FIG. 3 is displayed on the display unit 18. More specifically, when the viewer's limiting information is already registered in the storage unit 21, the display screen simply prompting for the selection of the viewer is presented, as shown in part (a) of FIG. 3. On the other hand, at the time of the initial setting or in the case of a new registration, a display screen prompting the viewer to input the limiting information (an input screen constructed as a WWW page) is presented, as shown in part (b) of FIG. 3.

Next, at the television broadcast receiver 2, as indicated at (3) in FIG. 2, the process proceeds to (17) in FIG. 2 where a scenario number of an advertising information is determined based on the limiting information. That is, when items such as age and sex are inputted and registered, the scenario number is determined that specifies the display of the advertising information that matches the limiting information.

Next, the television broadcast receiver 2 starts the reception of the contents at (4) in FIG. 2. That is, the restart request frame is sent to the broadcast station 1. Then, the television broadcast receiver 2 continues to receive the contents for 900 seconds, as indicated at (5) in Figure.2.

After sending the pause request frame at (6) in FIG. 2, the television broadcast receiver 2 displays the advertising information in accordance with the scenario number. As indicated at (7) in FIG. 2, the television broadcast receiver 2 continues to display the advertising information for 120 seconds.

Next, as indicated at (8) in FIG. 2, the television broadcast receiver 2 sends the restart request frame to the broadcast station 1 and restarts the reception of the contents.

Thereafter, the same operation is repeated in the television broadcast receiver 2, but as indicated at (10) in FIG. 2, it is also possible to present the same advertising information to all the viewers regardless of the scenario number. Further, as indicated at (15) in FIG. 2, it is also possible to continue to display the advertising information as long as there is no input from the viewer.

As described above, according to the broadcast system and advertising method of the first embodiment, the television broadcast receiver 2 comprises the browser unit 24 for reproducing the display data coded by the HTML, and a storage unit 21 for storing at least one piece of advertising information. The television broadcast receiver 2, using the browser unit 24, reproduces the advertising information stored in the storage unit 21 during the reception and reproduction of the contents in accordance with the contents of the advertising scenario header corresponding to the contents. Furthermore, according to the broadcast system and advertising method of the first embodiment, since the advertising information (commercial) is created using HTML, the advertising information can be produced at low cost, and thus a variety of commercials can be easily presented to the viewer. As a result, many pieces of contents can be presented to the viewer free of charge or at low cost. Further, the broadcast station 1 periodically accesses the advertiser's WWW server 27 to collect advertising information. The broadcast system and advertising method of the first embodiment thus allows the advertiser to update the advertising information easily. Furthermore, according to the broadcast system and advertising method of the first embodiment, since the advertising information that matches the attributes of the viewer can be presented for viewing to the viewer on the basis of the advertising scenario header, and furthermore, since feedback from the viewer can be obtained, advertisements with enhance interactivity can be produced.

In the broadcast system and advertising method of the first embodiment, the viewer may be prompted to input data to the displayed advertising information by an instruction contained in the advertising scenario header; in this case, provision may be made to restart the reproduction of the contents when prescribed time has elapsed without any input from the viewer. Alternatively, provision may be made to stop the transmission of the contents completely, not temporarily, when prescribed time has elapsed. Such provision serves to prevent a situation in which the viewer would end up inputting nothing.

### Embodiment 2

FIG. 4 is a block diagram showing the configuration of a broadcast system according to a second embodiment of the present invention. In the broadcast system configuration of this embodiment, an Internet access unit 56 for accessing the Internet is added in the television broadcast receiver 32. The other elements are the same as the corresponding elements shown in the first embodiment, and therefore a description of those elements will not be repeated herein.

As shown in FIG. 4, the broadcast system of the second embodiment differs from that of the first embodiment in that the data transmitting unit 37 and data receiving unit 39 in the broadcast station 31 are connected to the router 44. Another difference is that the television broadcast receiver 32 is equipped with the Internet access unit 56 for accessing HTML-coded display data on the Internet 57. The broadcast system of the second embodiment thus allows the television broadcast receiver 32 to access the advertiser's WWW server 58 on the Internet 57. The storage unit 51 stores therein basic advertising information, that is, advertising information consisting, for example, only of still images, and by default, the basic advertising information is displayed. As a result, in the broadcast system of the second embodiment, when access to the Internet 57 is slow due to congestion, the viewer's waiting time due to delays in accessing the Internet can be reduced, because then the adverting information stored in the storage unit 51 can be displayed. Furthermore, if the viewer is interested, more detailed advertising information, for example, advertising information containing moving images, can be displayed as the advertising information by accessing the Internet 57.

In the broadcast system of the second embodiment, a data gathering unit 59 is provided on the Internet 57. The data gathering unit 59 gathers data on advertising information viewing status collected from the television broadcast receiver 32. The broadcast system of the second embodiment thus allows the advertiser to gather information such as the viewer's impressions of the commercial and the advertised product. Furthermore, the viewer can order the advertised product on the spot. The data gathering unit 59 may be provided within the broadcast station 31.

### Operation of the Broadcast System

Operation of the broadcast system configured as described above will be described in detail with reference to FIG. 4. The following description deals mainly with differences from the first embodiment.

The advertising information server 42 accesses the advertiser's WWW server 58 on the Internet 57 via the router 44, and stores the obtained advertising information in the advertising information storage unit 43. The stored advertising information is transmitted, for example, late at night, for storing in the storage unit 51. While the advertising scenario header of the foregoing first embodiment carries descriptions instructing to only display the advertising information stored in the storage unit 51, the advertising scenario header of the second embodiment carries descriptions instructing to also display the advertising information obtained by directly accessing the advertiser's WWW server 58 on the Internet 57, over and above the advertising information stored in the storage unit 51.

The process in which the television broadcast receiver 32 receives the advertising scenario header from the broadcast station 31 is the same as that described in the first embodiment. The contents of the received advertising scenario header are different from those in the first embodiment, as just described.

Referring now to FIG. 5, the operation of the television broadcast receiver 2, performed in accordance with the advertising scenario header of the second embodiment, will be described in detail below.

FIG. 5 is an explanatory diagram showing a specific example of the advertising scenario header used in the broadcast system of FIG. 4.

The advertising scenario header of the second embodiment differs from that of the first embodiment in the descriptions shown at (14) in FIG. 5. That is, in the advertising scenario header of the second embodiment, a URL is indicated for each scenario, as shown at (14) in FIG. 5, instructing to access the specified advertiser's WWW server 58 on the Internet 57.

At (14) in FIG. 5, the browser unit 54 instructs the Internet access unit 56 to access the advertiser's WWW server 58 at the specified URL. The Internet access unit 56 creates a packet requesting that advertising information written in HTML be acquired from the advertiser's WWW server 58 specified in the advertising scenario header in accordance with the Hyper Text Transfer Protocol (HTTP). The Internet access unit 56 passes the thus created packet to the data transmitting unit 52, instructing it to transmit out the packet. The data transmitting unit 52 then creates a data frame containing the packet, and passes the data frame to the data modulating/demodulating unit 49. The data modulating/demodulating unit 49 codes and modulates the data frame and transmits it onto the cable television network 33 via the multiplexing/demultiplexing unit 45.

At the broadcast station 41, the data frame is received via the multiplexing/demultiplexing unit 41 and demodulated and decoded by the data modulating/demodulating unit 40. The data frame is then passed to the data receiving unit 39. The data receiving unit 39 recognizes it as a data frame, extracts the packet contained in the data frame, and transmits it onto the Internet via the router 44.

The advertising information from the advertiser's WWW server 58 is packetized and delivered to the data transmitting unit 37 via the router 44. The data transmitting unit 37 creates a data frame containing the packets received via the router 44, and transfers the data frame to the data modulating/demodulating unit 40. The data modulating/demodulating unit 40 codes and modulates the data frame and transmits it onto the cable television network 33 via the multiplexing/demultiplexing unit 41.

At the television broadcast receiver 32, the data frame is received via the multiplexing/demultiplexing unit 45 and inputted to the data modulating/demodulating unit 49. The data modulating/demodulating unit 49 demodulates and decodes the received data frame, and passes it to the data receiving unit 50. The data receiving unit 50 recognizes the received frame as a data frame, extracts the advertising information packets from the data frame, and passes them to the Internet access unit 56. The Internet access unit 56 extracts the advertising information, and sends it to the browser unit 54 which presents the advertising information for display on the display unit. In actuality, to access one piece of advertising information, requests and transmit and acknowledge packets are exchanged several times in accordance with HTTP, and the transmission and reception of the packets are performed by repeating the above procedure.

Further, even when an instruction is given in the advertising scenario header to display the advertising information stored in the storage unit 51, an instruction to access the corresponding advertiser's WWW server 58 on the Internet 57 may be added to (or included in) advertising information pre-stored in the storage unit 51. In this case also, the television broadcast receiver 32 accesses the Internet 57 in the same manner as earlier described.

Data communication between the Internet access unit 56 and the data gathering unit 59 is performed in the following manner.

When the browser unit 54 in the television broadcast receiver 32 displays, in accordance with the advertising scenario header in the storage unit 51, the advertising information stored in the storage unit 51 or retrieved from the advertiser's WWW server 58 on the Internet 57, the browser unit 54 reports the identifier of the displayed advertising information to the Internet access unit 56. Then, the Internet access unit 56 creates a packet of the format predetermined between it and the data gathering unit 59, and passes the packet to the data transmitting unit 52. The packet contains at least the identifier of the advertising information, and may further contain the identifier of the contents and the viewer's personal information such as age, etc. The data transmitting unit 52 creates a data frame containing this packet, and passes it to the data modulating/demodulating unit 49. After that, the packet is transmitted to the data gathering unit 59 in the same manner that the data frame for requesting the advertising information is transmitted to the advertiser's WWW server 58. In this way, the data gathering unit 59 gathers advertising information viewing status from many television broadcast receivers 32, and provides the data to the advertiser.

As described above, according to the broadcast system and advertising method of the second embodiment, the data transmitting unit 37 and data receiving unit 39 in the broadcast station 31 are connected to the router 44. Further, the television broadcast receiver 32 includes the Internet access unit 56 for accessing HTML-coded display data on the Internet 57. The broadcast system and advertising method of the second embodiment thus allows the television broadcast receiver 32 to access the advertiser's WWW server 58 on the Internet 57. As a result, in the broadcast system and advertising method of the second embodiment, besides the advertising information stored in advance in the storage unit 51 in the television broadcast receiver 32, the advertiser's latest advertising information can be provided to the viewer by directly accessing the advertiser's WWW server 58 on the Internet 57. Furthermore, the advertiser and the viewer can perform interactive data communication directly between them, and an enhanced advertising effect can thus be obtained. Moreover, it is also possible to produce advertising information that allows the viewer to order the advertised product on the spot; in this way, advertising information that instantly results in the sale of the product can be produced.

Furthermore, according to the broadcast system and advertising method of the second embodiment, since advertisement viewing status can be gathered from viewers, not only can the advertising information be produced more effectively, but the gathered information can also be used to determine the share of each advertiser to bear the production cost of the contents.

As described above, according to the broadcast system and advertising method of the present invention, the television broadcast receiver comprises a browser unit for reproducing display data coded by the Hyper Text Markup Language, and a storage unit for storing at least one piece of advertising information. In the television broadcast receiver, the advertising information stored in the storage unit is reproduced by means of the browser unit during the reception and reproduction of contents in accordance with the contents of the advertising scenario header corresponding to the contents. Furthermore, according to the broadcast system and advertising method of this invention, since the advertising information (commercial) is created using HTML, the advertising information can be produced at low cost, and thus a variety of commercials can be easily presented to the viewer. As a result, many pieces of contents can be presented to the viewer free of charge or at low cost. Moreover, producing the advertising information using HTML makes it easier for the advertiser to update the contents of the advertising information.

According to the broadcast system and advertising method in another aspect of the invention, the television broadcast receiver comprises a browser unit for reproducing display data coded by the Hyper Text Markup Language, and an Internet access unit for accessing the Internet to obtain the display data coded by the Hyper Text Markup Language. In the television broadcast receiver, during the reception and reproduction of contents the Internet access unit accesses the display data on the Internet and information obtained by accessing the display data is reproduced for display as the advertising information by means of the browser unit in accordance with the contents of the advertising scenario header corresponding to the contents. Accordingly, in the broadcast system and advertising method of this invention, commercials can be produced at low cost as in the first described invention, without providing a storage unit in the television broadcast receiver. Furthermore, the advertiser can update the contents of the advertising information any time when the need arises, and the viewer can thus view the latest advertising information.

According to the broadcast system and advertising method in another aspect of the invention, the television broadcast receiver comprises a browser unit for reproducing display data coded by the Hyper Text Markup Language, a storage unit for storing at least one piece of advertising information, and an Internet access unit for accessing the Internet to obtain the display data coded by the Hyper Text Markup Language. In the television broadcast receiver, during the reception and reproduction of contents the advertising information stored in the storage unit is reproduced by the browser unit and information obtained through the Internet access unit by accessing the display data on the Internet is reproduced for display as the advertising information by means of the browser unit in accordance with the contents of the advertising scenario header received from the broadcast station. Furthermore, according to the broadcast system and advertising method of this invention, basic advertising information, that is, advertising information consisting, for example, only of still images, is stored in the storage unit, and by default, the basic advertising information is displayed. Thus, according to the broadcast system and advertising method of this invention, there is offered, in addition to the effects of the foregoing aspects of the invention, the effect that when access to the Internet is slow due to congestion, the viewer's waiting time due to delays in accessing the Internet can be reduced, because then the adverting information stored in the storage unit can be displayed. Further, if the viewer is interested, more detailed advertising information, for example, advertising information containing moving images, can be displayed as the advertising information by accessing the Internet.

According to the broadcast system and advertising method in another aspect of the invention, the television broadcast receiver comprises an input unit for inputting data, in addition to the units described in the foregoing aspects of the invention. The advertising information includes input instruction of limiting information for reproducing a description instructing to input limiting information using the input unit, and the advertising scenario header includes information for instructing to resume the reproduction of the contents or the advertising information after data has been inputted using the input unit in response to the reproduced input instruction of limiting information, and also includes information for instructing to reproduce the advertising information that matches the contents of the limiting information. According to the broadcast system and advertising method of this invention, the television broadcast receiver is configured to reproduce the advertising information during the reproduction of contents in accordance with the contents of the advertising scenario header and the limiting information inputted from the input unit. The broadcast system and advertising method of this invention thus permits the viewer to view the advertising information that matches his or her interest. The advertiser, in turn, can deliver a commercial to the viewer on whom the commercial is likely to have an impact.

According to the broadcast system and advertising method in another aspect of the invention, the television broadcast receiver comprises, in addition to the units described in the foregoing aspects of the invention, a reproduction control unit for controlling the reproduction of contents. Using the reproduction control unit, the television broadcast receiver instructs the broadcast station to temporarily stop the transmission of the contents when starting the reproduction of the advertising information during the reception and reproduction of the contents and instructs the broadcast station to restart the transmission of the contents when ending the reproduction of the advertising information. In this way, the broadcast system and advertising method of this invention permits the television broadcast receiver to control the commercial displaying time; furthermore, since the reproduction of the contents is controlled at the television broadcast receiver side, the load at the broadcast station can be alleviated.

According to the broadcast system and advertising method in another aspect of the invention, a data gathering unit for receiving data transmitted from the television broadcast receiver and for storing the data is provided at least either in the broadcast station or on the Internet. The television broadcast receiver further comprises an input unit for inputting data and a data transmitting unit for transmitting data to the data gathering unit. The advertising information includes data input instruction information for reproducing a description instructing to input data using the input unit, and the advertising scenario header includes information for instructing to resume the reproduction of the contents or the advertising information after data has been inputted using the input unit in response to the reproduced data input instruction information. Further, in the broadcast system and advertising method of this invention, the television broadcast receiver transmits the contents of the data, inputted using the input unit, to the data gathering unit by means of the data transmitting unit. The broadcast system and advertising method of this invention thus allows the advertiser to gather information such as the viewer's impressions of the commercial and the advertised product. Furthermore, the viewer can order the advertised product on the spot.

Although the invention has been described in some detail dealing with the preferred embodiments, the configuration details of any of the preferred embodiments disclosed herein may be changed or modified, and any changes in the combination or order of elements thereof can be accomplished without departing from the spirit and scope of the invention as set forth in the appended claims.

1. A broadcast system comprising a broadcast station and a television broadcast receiver connected to said broadcast station by a two-way channel, wherein
said television broadcast receiver comprises a browser unit for reproducing display data coded by the Hyper Text Markup Language, and a storage unit for storing at least one piece of advertising information made up of display data coded by the Hyper Text Markup Language, and wherein
said broadcast station transmits, prior to or during the transmission of contents an advertising scenario header for at least instructing what kind of advertising information should be reproduced and in what way, and
during the reception and reproduction of said contents said television broadcast receiver reproduces said advertising information stored in said storage unit by means of said browser unit in accordance with the contents of said advertising scenario header received from said broadcast station.

2. A broadcast system comprising a broadcast station and a television broadcast receiver connected to said broadcast station by a two-way channel, wherein
said television broadcast receiver comprises a browser unit for reproducing display data coded by the Hyper Text Markup Language, and an Internet access unit for accessing the Internet to obtain display data coded by the Hyper Text Markup Language, and wherein
said broadcast station transmits, prior to or during the transmission of contents an advertising scenario header for at least instructing what kind of advertising information should be reproduced and in what way, and
during the reception and reproduction of said contents said television broadcast receiver accesses said display data on the Internet by means of said Internet access unit and reproduces information, obtained by accessing said display data, as said advertising information by means of said browser unit in accordance with the contents of said advertising scenario header received from said broadcast station.

3. A broadcast system comprising a broadcast station and a television broadcast receiver connected to said broadcast station by a two-way channel, wherein
said television broadcast receiver comprises a browser unit for reproducing display data coded by the Hyper Text Markup Language, a storage unit for storing at least one piece of advertising information made up of display data coded by the Hyper Text Markup Language, and an Internet access unit for accessing the Internet to obtain display data coded by the Hyper Text Markup Language, and wherein
said broadcast station transmits, prior to or during the transmission of contents an advertising scenario header for at least instructing what kind of advertising information should be reproduced and in what way, and
during the reception and reproduction of said contents said television broadcast receiver reproduces said advertising information stored in said storage unit by means of said browser unit and accesses said display data on the Internet by means of said Internet access unit and reproduces information, obtained by accessing said display data, as said advertising information by means of said browser unit in accordance with the contents of said advertising scenario header received from said broadcast station.

4. A broadcast system according to any one of claims 1 to 3, wherein
said television broadcast receiver comprises an input unit for inputting data,
said advertising information includes input instruction of limiting information for reproducing a description instructing to input limiting information using said input unit,
said advertising scenario header includes information for instructing to resume the reproduction of said contents or said advertising information after data has been inputted using said input unit in response to said reproduced input instruction of limiting information, and also includes information for instructing in accordance with the contents of said limiting information what kind of advertising information should be reproduced, and
said television broadcast receiver reproduces said advertising information during the reception and reproduction of said contents in accordance with the contents of said advertising scenario header and said limiting information inputted from said input unit.

5. A broadcast system according to any one of claims 1 to 3, wherein
said television broadcast receiver comprises a reproduction control unit for controlling the reproduction of said contents and
said television broadcast receiver instructs said broadcast station through said reproduction control unit to temporarily stop the transmission of said contents when starting the reproduction of said advertising information during the reception and reproduction of said contents, and instructs said broadcast station through said reproduction control unit to restart the transmission of said contents when ending the reproduction of said advertising information.

6. A broadcast system according to any one of claims 1 to 3, wherein
a data gathering unit for receiving data from said television broadcast receiver and for storing said data is provided at least either in said broadcast station or on the Internet,
said television broadcast receiver comprises a data input unit for inputting data, and a data transmitting unit for transmitting said data to said data gathering unit,
said advertising information includes data input instruction information for reproducing a description instructing to input data using said input unit,
said advertising scenario header includes information for instructing to resume the reproduction of said contents or said advertising information after said data has been inputted using said input unit in response to said reproduced data input instruction information, and
said television broadcast receiver transmits the contents of said data inputted from said input unit, to said data gathering unit by means of said data transmitting unit.

7. An advertising method for use in a broadcast system comprising a broadcast station and a television broadcast receiver connected to said broadcast station by a two-way channel, wherein
said television broadcast receiver comprises a browser unit for reproducing display data coded by the Hyper Text Markup Language, and a storage unit for storing at least one piece of advertising information made up of display data coded by the Hyper Text Markup Language, and wherein
an advertising scenario header for at least instructing what kind of advertising information should be reproduced and in what way, is transmitted from said broadcast station to said television broadcast receiver prior to or during the transmission of contents and
during the reception and reproduction of said contents said television broadcast receiver reproduces said advertising information stored in said storage unit by means of said browser unit in accordance with the contents of said advertising scenario header received from said broadcast station.

8. An advertising method for use in a broadcast system comprising a broadcast station and a television broadcast receiver connected to said broadcast station by a two-way channel, wherein
said television broadcast receiver comprises a browser unit for reproducing display data coded by the Hyper Text Markup Language, and an Internet access unit for accessing the Internet to obtain display data coded by the Hyper Text Markup Language, and wherein
an advertising scenario header for at least instructing what kind of advertising information should be reproduced and in what way, is transmitted from said broadcast station to said television broadcast receiver prior to or during the transmission of contents and
during the reception and reproduction of said contents said television broadcast receiver accesses said display data on the Internet by means of said Internet access unit and reproduces information, obtained by accessing said display data, as said advertising information by means of said browser unit in accordance with the contents of said advertising scenario header received from said broadcast station.

9. An advertising method for use in a broadcast system comprising a broadcast station and a television broadcast receiver connected to said broadcast station by a two-way channel, wherein
said television broadcast receiver comprises a browser unit for reproducing display data coded by the Hyper Text Markup Language, a storage unit for storing at least one piece of advertising information made up of display data coded by the Hyper Text Markup Language, and an Internet access unit for accessing the Internet to obtain display data coded by the Hyper Text Markup Language, and wherein
an advertising scenario header for at least instructing what kind of advertising information should be reproduced and in what way, is transmitted from said broadcast station to said television broadcast receiver prior to or during the transmission of contents and
during the reception and reproduction of said contents said television broadcast receiver reproduces said advertising information stored in said storage unit by means of said browser unit and accesses said display data on the Internet by means of said Internet access unit and reproduces information, obtained by accessing said display data, as said advertising information by means of said browser unit in accordance with the contents of said advertising scenario header received from said broadcast station.

10. An advertising method for use in a broadcast system according to any one of claims 7 to 9, wherein
said television broadcast receiver comprises an input unit for inputting data,
said advertising information includes input instruction of limiting information for reproducing a description instructing to input limiting information using said input unit,
said advertising scenario header includes information for instructing to resume the reproduction of said contents or said advertising information after data has been inputted using said input unit in response to said reproduced input instruction of limiting information, and also includes information for instructing in accordance with the contents of said limiting information what kind of advertising information should be reproduced, and
said television broadcast receiver reproduces said advertising information during the reception and reproduction of said contents in accordance with the contents of said advertising scenario header and said limiting information inputted from said input unit.

11. An advertising method for used in a broadcast system according to any one of claims 7 to 9, wherein
said television broadcast receiver comprises a reproduction control unit for controlling the reproduction of said contents and
said television broadcast receiver instructs said broadcast station through said reproduction control unit to temporarily stop the transmission of said contents when starting the reproduction of said advertising information during the reception and reproduction of said contents, and instructs said broadcast station through said reproduction control unit to restart the transmission of said contents when ending the reproduction of said advertising information.

12. An advertising method for use in a broadcast system according to any one of claims 7 to 9, wherein
a data gathering unit for receiving data from said television broadcast receiver and for storing said data is provided at least either in said broadcast station or on the Internet,
said television broadcast receiver comprises a data input unit for inputting data, and a data transmitting unit for transmitting said data to said data gathering unit,
said advertising information includes data input instruction information for reproducing a description instructing to input data using said input unit,
said advertising scenario header includes information for instructing to resume the reproduction of said contents or said advertising information after said data has been inputted using said input unit in response to said reproduced data input instruction information, and
said television broadcast receiver transmits the contents of said data inputted from said input unit, to said data gathering unit by means of said data transmitting unit.
